(19) United States
(12) Patent Application Publication
(10) Pub. No.: US 2026/0030870 A1
(43) Pub. Date: Jan. 29, 2026

(54) SYSTEMS AND METHODS FOR GEOLOGICAL ROCK CORE IMAGE ANALYSIS

(71) Applicant: Schlumberger Technology Corporation, Sugar Land, TX (US)

(72) Inventors: Siddharth Barua, Pune (IN); Sunil Manikani, Pune (IN); Eduardo Gonzalez Vega, Shamkha (AE)

(21) Appl. No.: 19/275,539

(22) Filed: Jul. 21, 2025

(30) Foreign Application Priority Data
Jul. 23, 2024 (IN) 202411055989

(51) Int. Cl. G06V 10/764; E21B 49/02; G06T 11/00; G06V 10/26; G06V 10/774; G06V 10/776; G06V 10/82

(52) U.S. Cl. CPC G06V 10/764; G06T 11/001; G06V 10/26; G06V 10/774; G06V 10/776; G06V 10/82; E21B 49/02

(57) ABSTRACT

A method includes: providing color images for a geological rock core sample, creating initial masks for a subset of the color images, dividing each color image into sets of image tiles, splitting the sets of image tiles into a training set and a validation set, augmenting the training and validation sets, including orienting each image tile in a same direction by sample depth, training a model with the augmented training validation sets, generating image masks from the trained model, corresponding to the color images, combining the sets of image tiles to regenerate each of the color images from their image tile sets, applying the generated image masks to the color images to generate greyscale masked images, stacking the greyscale masked images by sample depth, and applying colors to the stacked greyscale masked images to generate and display a stacked color image representing the entire sample length.

### CROSS-REFERENCE TO RELATED APPLICATION(S)

This application claims priority to and the benefit of Indian Provisional Patent Application No. 202411055989, filed on Jul. 23, 2024, the contents of which are incorporated by reference herein in its entirety for all purposes.

### TECHNICAL FIELD

This disclosure generally relates to systems and methods for geological rock core image analysis.

### BACKGROUND

A reservoir can be a subsurface geological formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

When core samples are taken from a subsurface geological formation, they are often physically arranged for examination and/or identification. Accordingly, there is a need for systems and methods for examination and/or identification of geological core samples. Also, there is a need for systems and methods for geological rock core image analysis.

### SUMMARY

This disclosure pertains to systems and methods for geological rock core image analysis.

A first aspect of this disclosure pertains to a method for a geological rock core sample obtained from a geological formation, the method including: providing an input image dataset including a plurality of color images each corresponding to a portion of the geological rock core sample, performing data preparation including: supervised mask generation including creating initial masks for a subset of the plurality of color images, and image tiling including dividing each of the plurality of color images into respective sets of image tiles, performing model training including: splitting the sets of image tiles into at least a training set and a validation set, augmenting the training set and the validation set, the augmenting including orienting each image tile in the training set and the validation set in a same direction according to a depth of the geological rock core sample corresponding to each respective tile, and training a machine-learning model with the augmented training set and validation set, generating a plurality of image masks from the trained machine-learning model, the plurality of image masks respectively corresponding to the plurality of color images, performing output processing including: tile stitching including combining the sets of image tiles to regenerate each of the plurality of color images from their respective sets of image tiles, and mask application including applying the generated plurality of image masks to their corresponding to the plurality of color images on a pixel-by-pixel basis to generate a plurality of greyscale masked images, stacking the plurality of greyscale masked images according to an order of depth of the geological rock core sample, applying a plurality of colors to the stacked plurality of greyscale masked images on a pixel-by-pixel basis to generate a stacked color image representing an entire length of the geological rock core sample, the plurality of colors corresponding to colors of the geological rock core sample, and displaying the stacked color image.

A second aspect of this disclosure pertains to the method of the first aspect, and further includes: determining whether there is at least one missing rock section in the geological rock core sample, when there is at least one missing rock section, generating a corresponding synthetic rock section model in place of each at least one missing rock section, each synthetic rock section model corresponding to a prediction of a geological type of the respective at least one missing rock section, the prediction being generated from well log data corresponding to the geological rock core sample, and displaying an enhanced color stacked image including: the stacked color image, and each synthetic rock section model in a respective location in the stacked color image corresponding to a location of the at least one missing rock section.

A third aspect of this disclosure pertains to the method of the second aspect, and further includes: generating facies classifications along an entire length of the enhanced stacked color image, and displaying the facies classifications on an electronic display device.

A fourth aspect of this disclosure pertains to the method of the third aspect, wherein the enhanced stacked color image includes a plurality of colors respectively corresponding to the facies classifications.

A fifth aspect of this disclosure pertains to the method of the third aspect, wherein the facies classifications are determined according to Euclidean distance values determined on a pixel-by-pixel basis from the enhanced stacked color image.

A sixth aspect of this disclosure pertains to the method of the third aspect, and further includes identifying a location of a target resource in the geological rock core sample based on the facies classifications.

A seventh aspect of this disclosure pertains to the method of the sixth aspect, and further includes performing a drilling operation to recover the target resource at a depth in the geological formation corresponding to the identified location of a target resource in the geological rock core sample.

An eighth aspect of this disclosure pertains to the method of the first aspect, wherein the machine-learning model includes a convolutional neural network (CNN) architecture.

A ninth aspect of this disclosure pertains to the method of the eighth aspect, wherein the CNN architecture includes a U-net segmentation model.

A tenth aspect of this disclosure pertains to the method of the ninth aspect, wherein the U-net segmentation model uses: a max pooling downsampling process, and a sigmoid activation function to generate the plurality of image masks.

An eleventh aspect of this disclosure pertains to a system, including: one or more processors, at least one memory including at least one non-transitory computer-readable medium storing instructions that, when executed by at least one of the one or more processors, cause the system to perform operations, the operations including: providing an input image dataset including a plurality of color images each corresponding to a portion of a geological rock core sample obtained from a geological formation, performing data preparation including: supervised mask generation including creating initial masks for a subset of the plurality of color images, and image tiling including dividing each of the plurality of color images into respective sets of image tiles, performing model training including: splitting the sets of image tiles into at least a training set and a validation set, augmenting the training set and the validation set, the augmenting including orienting each image tile in the training set and the validation set in a same direction according to a depth of the geological rock core sample corresponding to each respective tile, and training a machine-learning model with the augmented training set and validation set, generating a plurality of image masks from the trained machine-learning model, the plurality of image masks respectively corresponding to the plurality of color images, performing output processing including: tile stitching including combining the sets of image tiles to regenerate each of the plurality of color images from their respective sets of image tiles, and mask application including applying the generated plurality of image masks to their corresponding to the plurality of color images on a pixel-by-pixel basis to generate a plurality of greyscale masked images, stacking the plurality of greyscale masked images according to an order of depth of the geological rock core sample, applying a plurality of colors to the stacked plurality of greyscale masked images on a pixel-by-pixel basis to generate a stacked color image representing an entire length of the geological rock core sample, the plurality of colors corresponding to colors of the geological rock core sample, and displaying the stacked color image.

A twelfth aspect of this disclosure pertains to the system of the eleventh aspect, wherein the operations further include: determining whether there is at least one missing rock section in the geological rock core sample, when there is at least one missing rock section, generating a corresponding synthetic rock section model in place of each at least one missing rock section, each synthetic rock section model corresponding to a prediction of a geological type of the respective at least one missing rock section, the prediction being generated from well log data corresponding to the geological rock core sample, and displaying an enhanced color stacked image including: the stacked color image, and each synthetic rock section model in a respective location in the stacked color image corresponding to a location of the at least one missing rock section.

A thirteenth aspect of this disclosure pertains to the system of the twelfth aspect, wherein the operations further include: generating facies classifications along an entire length of the enhanced stacked color image, and displaying the facies classifications on an electronic display device.

A fourteenth aspect of this disclosure pertains to the system of the thirteenth aspect, wherein the enhanced stacked color image includes a plurality of colors respectively corresponding to the facies classifications.

A fifteenth aspect of this disclosure pertains to the system of the thirteenth aspect, wherein the facies classifications are determined according to Euclidean distance values determined on a pixel-by-pixel basis from the enhanced stacked color image.

A sixteenth aspect of this disclosure pertains to the system of the thirteenth aspect, wherein the operations further include identifying a location of a target resource in the geological rock core sample based on the facies classifications.

A seventeenth aspect of this disclosure pertains to the system of the sixteenth aspect, wherein the operations further include performing a drilling operation to recover the target resource at a depth in the geological formation corresponding to the identified location of a target resource in the geological rock core sample.

A eighteenth aspect of this disclosure pertains to the system of the eleventh aspect, wherein the machine-learning model includes a convolutional neural network (CNN) architecture.

A nineteenth aspect of this disclosure pertains to the system of the eighteenth aspect, wherein the CNN architecture includes a U-net segmentation model.

A twentieth aspect of this disclosure pertains to the system of the nineteenth aspect, wherein the U-net segmentation model uses: a max pooling downsampling process, and a sigmoid activation function to generate the plurality of image masks.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

The patent or application file contains at least one drawing executed in color. Copies of this patent or patent application publication with color drawing(s) will be provided by the Office upon request and payment of the necessary fee.

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a schematic view illustrating an example of a geologic environment.

FIG. 2 is a photograph of a geological rock core sample study setup.

FIG. 3 is an example workflow for geological rock core sample analysis.

FIG. 4 is an example workflow for geological rock core sample analysis.

FIG. 5 is an example of an experimental input.

FIG. 6 is a schematic representation of a U-Net convolutional neural network (CNN) architecture.

FIG. 7 is a schematic representation of a U-Net convolutional neural network (CNN) architecture.

FIG. 8 is an example of a depth-stacked core image.

FIG. 9 is sets of image-mask pairs from experimental results.

FIG. 10 is a flow of an example process for stitching mask chunks together.

FIG. 11 is a flow of an example process for a vertical stacking algorithm.

FIG. 12 is a workflow of an original image and a set of graphs corresponding to aspects of the original image.

FIG. 13 is a workflow for generating a preliminary lithofacies log.

FIG. 14 is a comparison of an original rock core image to a synthetic rock core image.

FIG. 15 is a flowchart of an example method for a geological rock core sample obtained from a geological formation.

FIG. 16 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

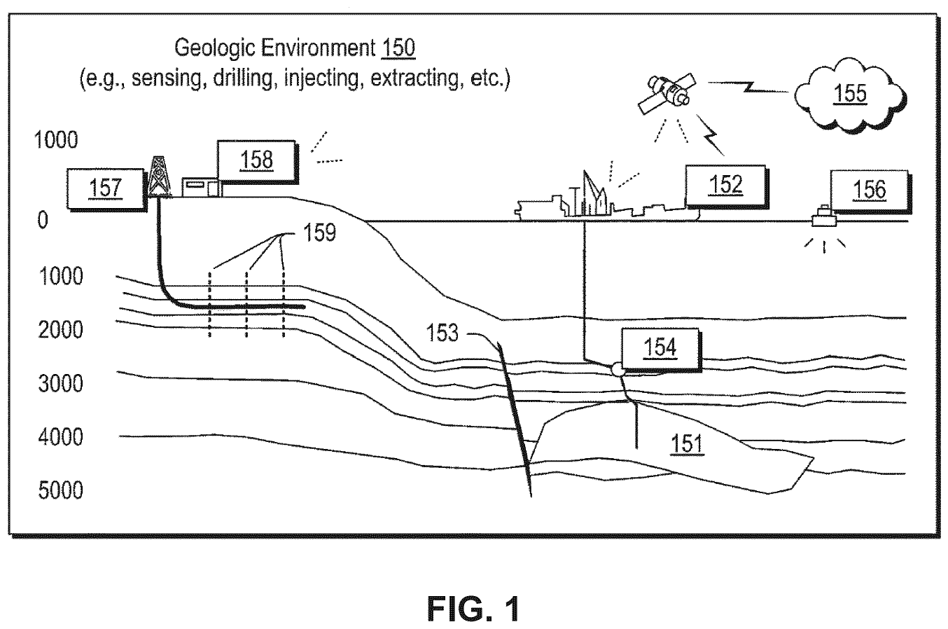

FIG. 1 is a schematic view illustrating an example of a geologic environment.

In the example of FIG. 1, an example geologic environment 150 may include layers (e.g., stratification) that may include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the one or more networks 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled at a wellsite for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

Convolutional neural networks (CNNs) are a type of deep learning model designed for analyzing visual data. They are highly effective in tasks such as image classification, object detection, and segmentation. CNNs use convolutional layers that automatically and adaptively learn spatial hierarchies of features from input images. This involves applying filters to the input image to capture patterns such as edges, textures, and more complex shapes in deeper layers.

CNNs are widely used in various image analysis applications, including medical imaging for disease detection, autonomous driving for object recognition, facial recognition systems, and more, due to their ability to accurately capture spatial dependencies in images and generalize well across different visual tasks.

The workflow defined herein according to example embodiments uses these abilities along with image data pertaining to geological rock core tray image datasets in the oil and gas industry, along with customized image processing, to effectively extract and analyze the rock material in the image dataset, thereby enabling and aiding advanced geological interpretations that can greatly impact hydrocarbon discovery and extraction and studies therefore.

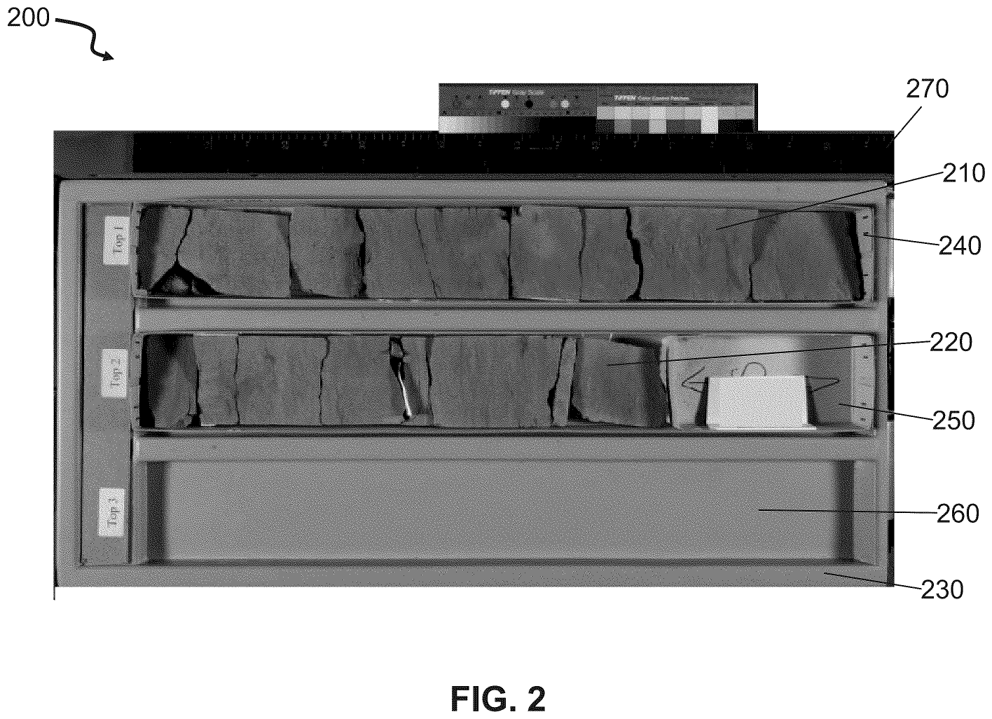

FIG. 2 is a photograph of a geological rock core sample study setup.

The existing conventional methodologies are solely manual, and are often known to be biased by human error and by subjective visual interpretation. Typically, a physical geological rock core sample is placed in a rock core sample study setup, such as the rock core sample study setup 200 shown in FIG. 2. In the rock core sample study setup 200, portions of a rock core sample 210, 220 are placed in a tray 230 and laid in depressions 240, 250, 260 in the tray in positions corresponding to the depth at which the sample 210, 220 was taken, with a break in the sample 210, 220 as needed to fit in the tray 230. In some examples, a ruler or other measurement device, e.g., ruler 270, may be included in the input image, such as in the photograph of the rock core sample study setup 200. The size of the tray 230 is typically limited due, for example, due to the space a tray would take up on a table while being examined by human investigators. A rock core sample can potentially be very long, requiring multiple trays, each having multiple depressions. Typically, it would not be practical to have the entire rock core sample arranged in a single line or column (or row) because of physical space available where the rock core sample is being analyzed and/or practicality of movement of the human investigators along a long column of rock.

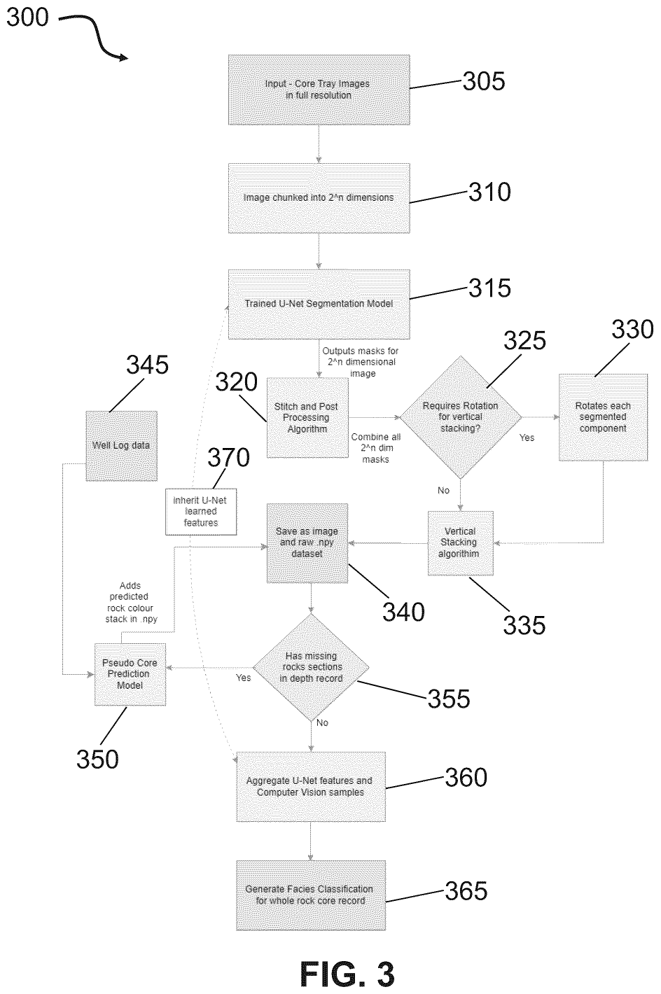

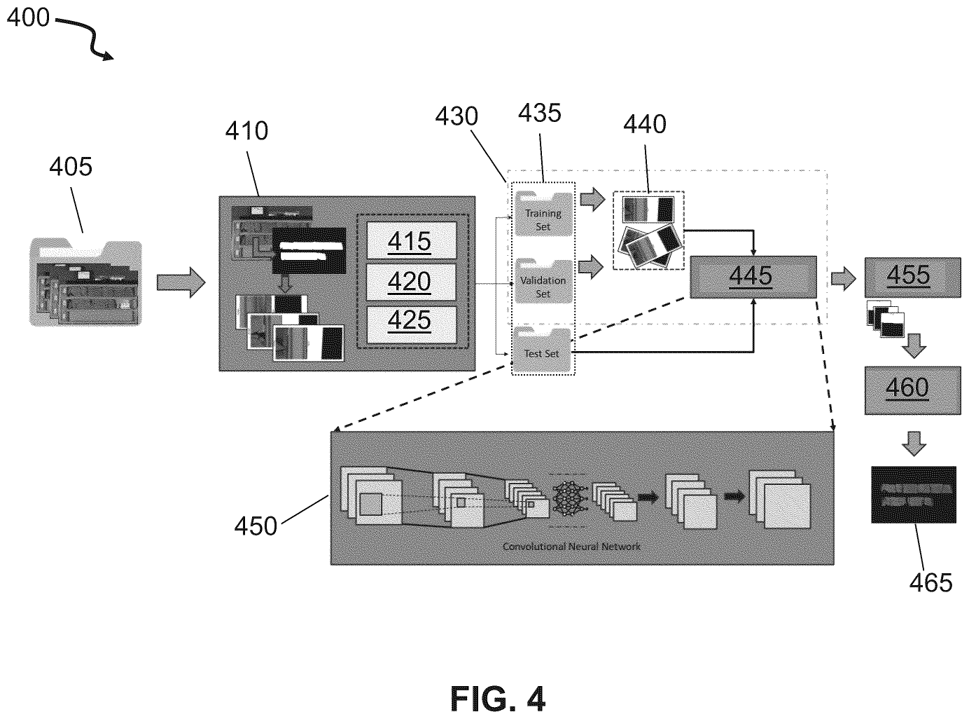

FIG. 3 is an example workflow for geological rock core sample analysis. FIG. 4 is an example workflow for geological rock core sample analysis.

A workflow in accordance with an example embodiment may take an input, for example, as a full high resolution geological rock core tray image, such as the photograph of FIG. 2, and may output two deliverables:
1. A complete extraction of rock slabs vertically stacked and depth aware. This may include taking information from the start and end depth from a well record, in both high resolution image (e.g., .png, jpeg, and the like) and one or more easily iterable raw files (e.g., .npy) which can serve as a starting point for a viewer or core image browser application. This deliverable may account for missing rock core regions, for example, by adding a “pseudo core” color stack. The pseudo core may serve as a reference for otherwise missing data. The pseudo core may be predicted, for example, using well logs if logging has been carried out in cored wells, in nearby wells, and/or the same well.
2. A lithological variation log along with the above deliverable of the complete extraction of rock slabs. The lithological variation may be generated, for example, using color data extracted from the stacked rock core image, as well as feature data from a model, e.g., a U-Net model.

AU-Net model is a type of deep convolutional neural network (DCNN) designed for image segmentation. It utilizes an encoder-decoder architecture, which is a common approach in semantic segmentation to generate detailed and accurate outputs. The encoder section captures contextual information by downsampling the input image through multiple convolutional and pooling layers. Meanwhile, the decoder section upsamples the features back to the original image size using transposed convolutions. Skip connections are incorporated to preserve spatial information that might be lost during the downsampling process.

With reference to FIG. 3, an example workflow 300 for geological rock core sample analysis may be provided. FIG. 3 is an example workflow, which may be for an end to end enhancement, e.g., to digitize the core tray image. The example workflow 300 may include an input block 305 in which core tray images may be input to a computing system in full resolution. These images may be the primary data source for the subsequent operations. At block 310, the full-resolution images may then be divided into smaller chunks, for example, each with dimensions of 2ⁿ. Next, at block 315, a convolutional neural network, e.g., a U-Net model, may be used to segment the images. This model may be trained to recognize and delineate different features within the images. The U-Net model may output masks for each of the 2ⁿ dimensional image chunks. These masks may highlight specific features or areas of interest within the images. At block 320, the masks may be stitched together, and a post-processing algorithm may be applied. The system may thereby combine the 2ⁿ segmented chunks back into a coherent whole and refine the segmentation results. All the masks from the 2ⁿ dimensional chunks may be combined, which may form a comprehensive representation of the core tray images.

Next, at block 325, the process may check whether the segmented components need to be rotated for vertical stacking. If rotation is required (“Yes” at block 325), then each segmented component may be rotated accordingly at block 330. A vertical stacking algorithm may then be applied at block 335, which may involve arranging the segmented components in a specific order or orientation, e.g., as a single vertical column of the rock core sample images. If no rotation is needed (“No” at block 325), then the workflow 300 may proceed to the vertical stacking at block 335 without altering the orientation of the components. Next, the processed data may be saved at block 340, for example, both as an image and in a raw dataset format, e.g., .npy, which is a common format for storing numerical array data, such as in PYTHON®.

Well log data may be integrated into the workflow 300 at block 345, which may provide additional geological information that can be used alongside the input image data. At block 350, a pseudo core prediction model may be used to make predictions about the core samples, which may infer properties or characteristics that are not directly visible (or missing) in the images. The inferences may be made from the well log data from block 345. For example, the pseudo core prediction model may fill in spaces where no rock sample is present at a given depth, e.g., based on the well log data taken at the given depth, to predict what would have been in the image if a physical sample had been present at the given depth. For example, the workflow 300 may add a predicted rock color stack to at least the raw dataset (e.g., the .npy dataset), which may provide additional data for analysis. The pseudo core prediction model from block 350 may be incorporated into the image and raw dataset at block 340.

At block 355, the workflow 300 may check to determine whether there are missing rock sections in the depth record. If there are missing sections (“Yes” at block 355), the process may continue to block 350 to fill in the missing sections using a pseudo core prediction model. If no sections are missing (“No” at block 355), the workflow 300 may continue without additional adjustments. At block 360, features from the CNN (e.g., U-Net) model and samples from computer vision analyses may be aggregated. At block 365, the workflow 300 may include generating a facies classification for the entire rock core record, which may provide an analysis of the geological features present for the fully-imaged and filled-in rock core sample. The various layers in the fully-imaged and filled-in rock core sample may be identified (e.g., classified), which may include identifying the type(s) of material along the depth of the sample, the type(s) of geological formation at a given depth along the depth of the sample, and/or other information about the sample along the depth of the sample, such as petrophysical parameters and properties. Also, the CNN model (e.g., U-Net model) may inherit features learned by the model (block 370), for example, whenever the model is used, which may enhance the accuracy of subsequent predictions or classifications.

With reference to FIG. 4, an example workflow 400 for geological rock core sample analysis may be provided. The example workflow 400 may include more detailed features for blocks 305, 310, 315, 325, 330, 335, and 340 of the FIG. 3 example. For example, the workflow 400 may include providing an input dataset at block 405, which may include color images corresponding to respective portions along the length of a geological rock core sample. In an experiment using an example embodiment, the input included open-source data from the British Geological Survey (BGS) United Kingdom Continental Shelf (UKCS) hydrocarbon well data repository. In the experiment, the images had a resolution of 7129×4740 pixels. At block 410, a data preparation operation may be performed. For example, the data preparation may include supervised mask generation (block 415), image tiling (block 420), and normalization (block 425). The mask generation may include creating masks for the images for a subset of the images, which may be, for example, a small representative set of the data. This operation may be performed manually, although example embodiments are not limited thereto. In the experiment, the mask generation was performed by using an open source manual image segment creation tool, but example embodiments are not limited thereto. The image tiling may include dividing images into smaller tiles. For example, in the experiment, tiles of 512×512 pixels were used. The normalization may include standardizing the image data.

Next, the workflow 400 may include model training at block 430. The model training may include data splitting (block 435), data augmentation (block 440), and training a machine-learning model by feeding the augmented data into the machine-learning model (block 445). For the data splitting, the prepared data may be split into training, validation, and test sets. The data augmentation may include techniques that may be applied to enhance the training data, e.g., a vertical flip of the image, a horizontal flip of the image, one or more rotations of the image, and the like. The machine-learning model may include, for example, any one or more of a neural network, and artificial intelligence, a deep learning model, convolutional neural network (CNN), a U-Net model, or the like. In the model training in the experiment, a convolutional neural network (CNN) (block 450) was used for training on the image data. For example, a U-Net model was trained on the experimental dataset. The model may then output an image mask corresponding to each of the input images at block 455, which may be greyscale image masks.

Next, the workflow 400 may include output processing at block 460. The output processing may include tile stitching, post-processing, and mask application. The tile stitching may include combining the tiles back into full images, e.g., regenerating the original plurality of images from their constituent tiles. The post-processing may include refining the output. The mask application may include applying the generated masks, which may be greyscale masks, to the images, which may be color images, for example on a pixel-by-pixel basis, to generate a plurality of greyscale masked images. At block 465, the workflow 400 may include an image mask output, which may include producing the segmented masked images for stacking into a full visualization of the plurality of masked images according to an order of depth of the geological rock core sample. The full visualization stacked mask may then be applied to the original images, e.g., on a pixel-by-pixel basis, to create a stacked color image representing an entire length of the geological rock core sample, as in block 335 of the example workflow of FIG. 3. For example, colors may be applied to the stacked plurality of greyscale masked images on a pixel-by-pixel basis to generate a stacked color image representing an entire length of the geological rock core sample. The colors may correspond to the colors of the geological rock core sample so that the displayed visualization of the stacked color image looks like the geological rock core sample would appear if it were laid out end-to-end along its entire length.

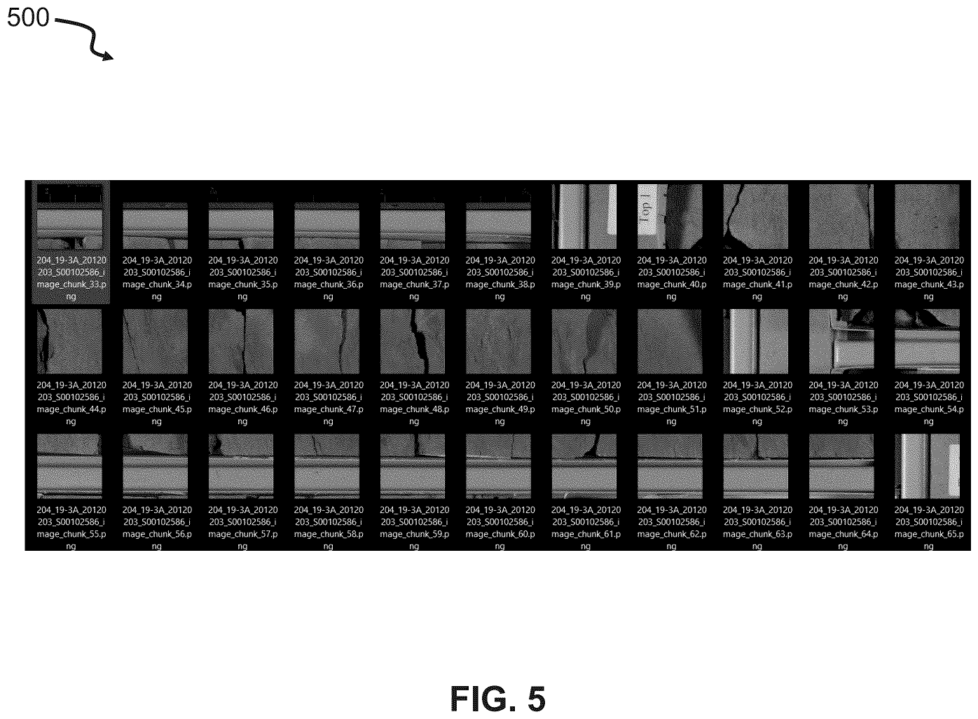

FIG. 5 is an example of an experimental input.

Input image: In experimental procedures, the images used to train, as well as to test, a UNet model were open-sourced data provided by the British Geological Survey (BGS) UKCS hydrocarbon well data repository. The entire dataset of ˜600 images of core trays was downloaded. Other data sets may also be used. Each image had a native resolution of 7129×4740 pixels, 96 dpi as a standard. FIG. 1 is an example of an image from the BGS dataset. It should be appreciated that embodiments are not limited to the numbers of pixels in the described examples.

Image Chunks in 2ⁿ Dimensions: The workflow may reduce load on computing resources by intelligently making square chunks of dimension 2ⁿ×2ⁿ. This operation may make it easier for the U-Net model to be able to encode and decode effectively in the square resolution without dimensionality issues. In the experimental workflow, given the resolution of the input and the level of detail, chunks of 512×512 pixels were made along with necessary padding where square dimension chunks were not possible. FIG. 5 shows the experimental input image 500 for the U-Net segmentation model. In FIG. 5, the FIG. 1 image was broken into square chunks of 512×512 pixels for input data into the U-Net CNN. It should be appreciated that embodiments are not limited to the numbers of pixels in the described examples.

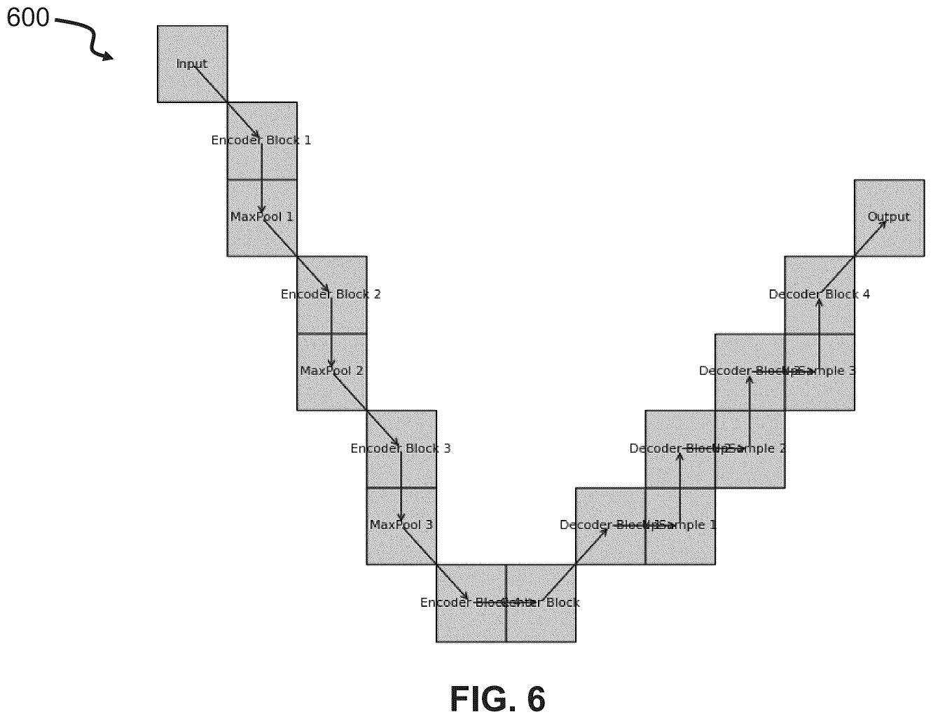

FIG. 6 is a schematic representation of a U-Net convolutional neural network (CNN) architecture.

FIG. 6 shows an example U-Net CNN architecture 600 as used in an experimental workflow for image segmentation.

U-Net Segmentation Model: A model used in an example embodiment of the workflow is a deep convolutional neural network (DCNN) architecture designed for image segmentation tasks. It employs a typical encoder-decoder structure, which is commonly used in semantic segmentation to produce detailed and precise outputs.

Encoder: The encoder may include, for example, five convolutional blocks, each containing multiple convolutional layers followed by max pooling. The convolutional layers use filters of varying sizes (e.g., 64, 128, 256, 512) to progressively extract more complex features from the input images. Each block may include, e.g., two or three convolutional layers, which may increase the number of filters with depth. Max pooling layers may reduce the spatial dimensions, allowing the model to learn hierarchical features efficiently. It should be appreciated that embodiments are not limited to the numbers of blocks or layers in the described examples.

Center Block: There may be two convolutional layers with batch normalization and rectified linear unit (ReLU) activation, which may be a bottleneck of the architecture. This central block may serve as a bridge between the encoder and decoder, which may capture high-level representations of the input data. The ReLU activation function may be defined as follows in Equation 1 below:

ReLU=max(0,z) [Equation 1]

In Equation 1, ‘z’ represents the input value to the neuron, and the ‘max’ function returns the maximum value out of zero and z.

Decoder: The decoder may mirror the encoder's structure, for example, employing upsampling layers and skip connections from corresponding encoder layers. These skip connections may help retain spatial information that might be lost during downsampling in the encoder. The decoder may reconstruct the image from the high-level features extracted by the encoder, gradually increasing the spatial resolution and decreasing the number of filters (for example, from 512 down to 16).

Output Layer: The final convolutional layer may reduce the output to the desired number of channels (for example, 1), which may be followed by a sigmoid activation function to produce a binary segmentation map.

The above-described experimental U-Net model included a total of 71,248,757 parameters, with 23,748,241 trainable parameters. This architecture may efficiently combine deep feature extraction with precise spatial reconstruction, making it suitable for high-resolution image segmentation tasks. The output may be a mask of the input image chunk dimension.

Model Training: The training pipeline for the image segmentation model involved generating image-mask pairs through supervised mask creation in experiments using example embodiments. This process entailed several key steps to ensure the model was trained effectively and could accurately segment relevant areas while omitting irrelevant ones.

Data Preparation: High-quality images and their corresponding masks may be created, with masks highlighting the relevant areas to be segmented. In the experiments, this supervised mask creation involved manually annotating the images to ensure a good balance between areas of interest and regions to omit.

Data Augmentation: To enhance the model's generalization ability, data augmentation techniques, such as rotation and flipping, may be applied to the image-mask pairs. This may help create a more diverse training set and prevent overfitting.

Model Initialization: The encoder-decoder CNN model may be initialized with appropriate weights. For the encoder part, pre-trained weights on a large dataset (e.g., resnet34) may be used to leverage learned features, while the decoder may be initialized randomly.

Training Configuration: The model may be compiled with a suitable loss function, e.g., binary cross-entropy, which may be effective for segmentation tasks. An Adam optimizer may be used to update the model weights during training.

Training Process: The model may be trained on the augmented dataset using a batch size and number of epochs determined through experimentation. During training, the model may learn to differentiate between relevant and irrelevant areas based on the provided masks, e.g., user-defined supervised masks. The balanced nature of the masks may ensure that the model does not over-segment or under-segment the images.

Validation and Fine-Tuning: A validation set, separate from the training set, may be used to monitor the model's performance, and prevent overfitting. Based on the validation results, hyperparameters may be fine-tuned, and early stopping or learning rate scheduling may be applied to optimize the training process.

Outcome: In experimental results, the balanced training approach, combined with supervised mask creation, resulted in a model capable of accurately segmenting relevant areas while effectively omitting irrelevant regions. The use of a robust training pipeline ensured the model's high performance and generalization ability.

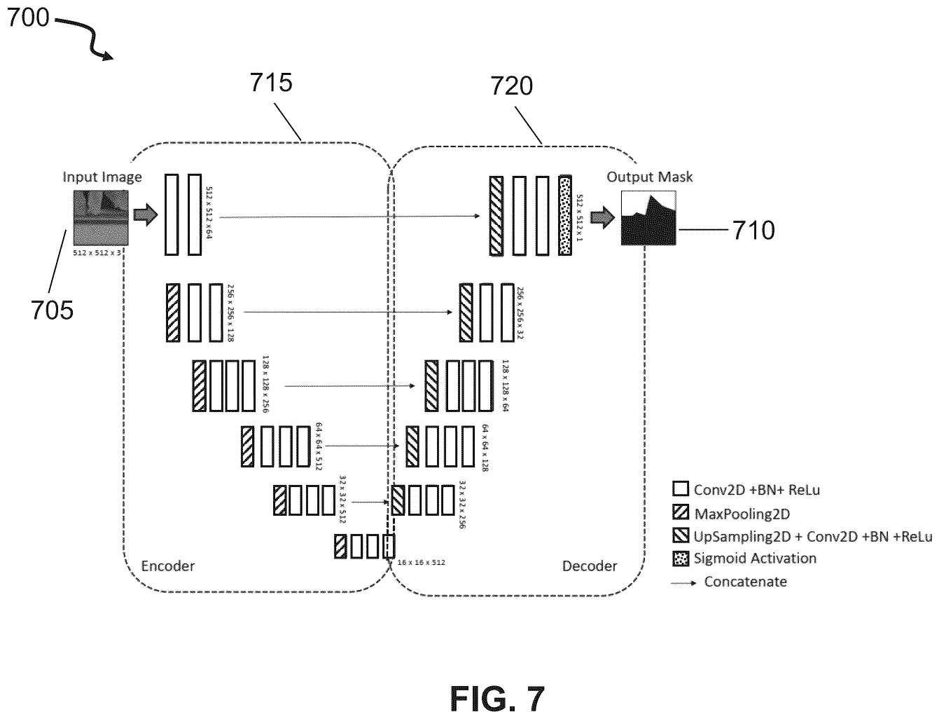

FIG. 7 is a schematic representation of a U-Net convolutional neural network (CNN) architecture.

FIG. 7 shows an example U-Net CNN architecture 700 as used in an experiment conducted in accordance with an example embodiment. The example architecture 700 received an input image 705, which included three 512×512 image chunks, and output an output mask 710. The example architecture 700 may include an encoder (or contracting path) 715. The encoder 715 may capture context by downsampling the input image, e.g., through a series of convolutional and pooling layers. The encoder 715 may reduce the spatial dimensions while increasing the depth, and may extract features at multiple levels. The example architecture 700 may further include a decoder (or expanding path) 720. The decoder 720 may upsample the features back to the original image size, e.g., using transposed convolutions. The decoder 720 may combine the upsampled features with corresponding features from the encoder path through skip connections, which may help retain spatial information that may have been lost during the downsampling of the encoder 715. Skip connections between the encoder 715 and decoder 720 paths may allow the network to use high-resolution features from the encoder 715, which may improve the accuracy of the segmentation.

U-Net excels at segmenting images into different regions or objects. For example, when used for analyzing geological cores, U-Net can differentiate between core segments and can differentiate non-rock areas accurately. Due to its efficient architecture, U-Net can achieve high accuracy with relatively few training images, making it suitable for applications where labeled data is scarce. In the experimental example image, the input image 705 was a tiled input image and the output mask 710 was a binary masked image having the same resolution as the input image 705.

Downsampling is the process of reducing the spatial dimensions (e.g., height and width) of an image while retaining important features. This is typically done using techniques such as pooling or strided convolutions. Methods for pooling include max pooling and average pooling. In max pooling, the maximum value from a set of pixels within a defined window is selected, while in average pooling, the average value is taken. This reduces the size of the image, but keeps the most significant features. Strided convolutions include convolutions with a stride greater than one. Strided convolutions can also reduce the spatial dimensions. For example, a stride of two (2) may halve the width and height of the feature map.

Upsampling is the process of increasing the spatial dimensions of an image, e.g., reversing downsampling. Upsampling may be done to bring the feature maps back to the original image size. Upsampling techniques include transposed convolutions (or deconvolutions), interpolation, and unpooling. Transposed convolutions (or deconvolutions) use kernels to increase the size of the feature maps. Transposed convolutions (or deconvolutions) are similar to regular convolutions, but work in the opposite direction. Interpolation, including nearest-neighbor, bilinear, or bicubic interpolation, can be used to resize images. Interpolation methods estimate pixel values to create a larger image. Unpooling reverses pooling by placing the pooled values back into their original positions, and is often combined with interpolation to fill in the gaps.

Downsampling may help to reduce computational complexity and captures abstract features at different levels of the image. Upsampling may restore the image to its original size, allowing for precise localization of features, which is important for tasks like image segmentation.

In a U-Net CNN, downsampling occurs in the encoder path, where the image is progressively reduced in size to capture context. Upsampling happens in the decoder path, where the image is expanded back to its original size, combining high-level features with detailed spatial information from the encoder through skip connections. U-Net CNNs may have a symmetric architecture, may use skip connections, may provide efficient training, may provide pixel-wise classification, and may provide a versatile and/or robust trained model.

The architecture 700 applied a convolutional layer (Conv2D), followed by batch normalization (BN), and then a ReLU activation function (ReLU) to the input image twice (blocks without shading corresponding to “Conv2D+BN+ReLu”). Then, downsampling was performed in the encoder 715 with a max pooling (blocks with left-diagonal shading corresponding to “Maxpooling2D”) performed five (5) times with successively downsampled layers. Subsequently, upsampling was performed in the decoder 720 with an unpooling (blocks with right-diagonal shading corresponding to “UpSampling2D+Conv2D+BN+ReLu”) performed five (5) times with successively upsampled layers. Then, a sigmoid activation function (block with dotted shading corresponding to “Sigmoid Activation”) was applied to generate the output mask 710.

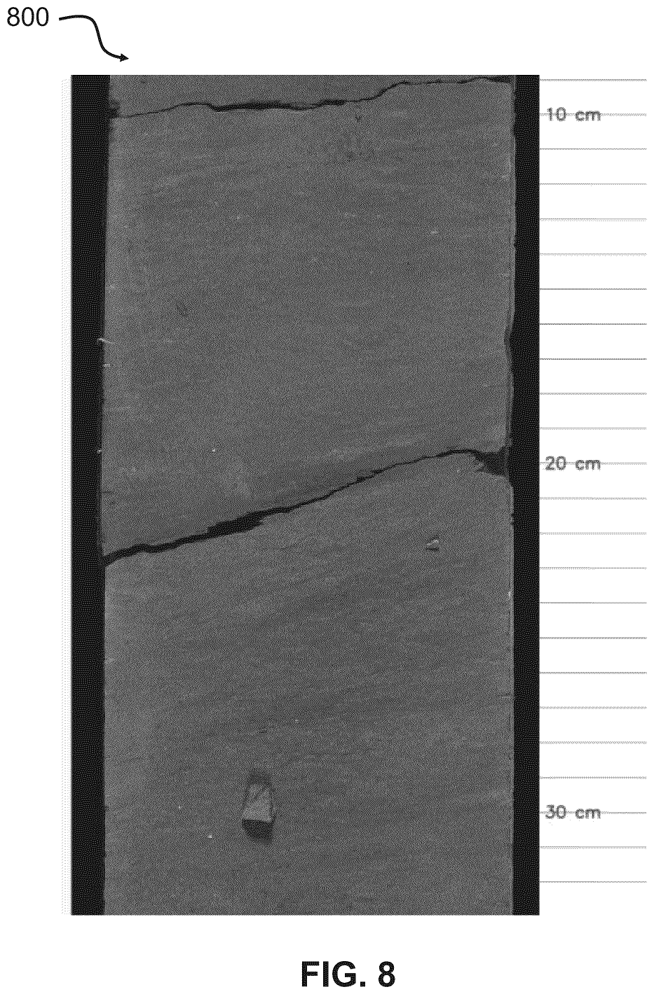

FIG. 8 is an example of a depth-stacked core image.

One of the products of the workflow is a depth-stacked core image which needs only to know the starting depth of the core from which it was recovered. FIG. 8 shows an example of a depth-stacked core image 800. Example embodiments may use controls that may include predetermined knowledge of how long each core segment column is going to be. Such predetermined knowledge may be easily determinable from a manual measurement of the original core tray, e.g., tray 230 of FIG. 2. Alternatively, example embodiments may use electronic control features, which may be provided, e.g., on a human display interface, such as a monitor, computer screen, display device, or other electronic display. An example of an electronic control feature may include a ruler, which may be provided, e.g., if available in the input image, such as the ruler 270 in FIG. 2.

The depth-stacked core image correlated with the extracted length of pixels from the region of interest. For example, if 7000 pixels are extracted from a region representing a 1 meter (m) (or 100 centimeter (cm)) total length of rock core, it can be determined that 70 pixels represents 1 cm (or 7 pixels per millimeter (mm)).

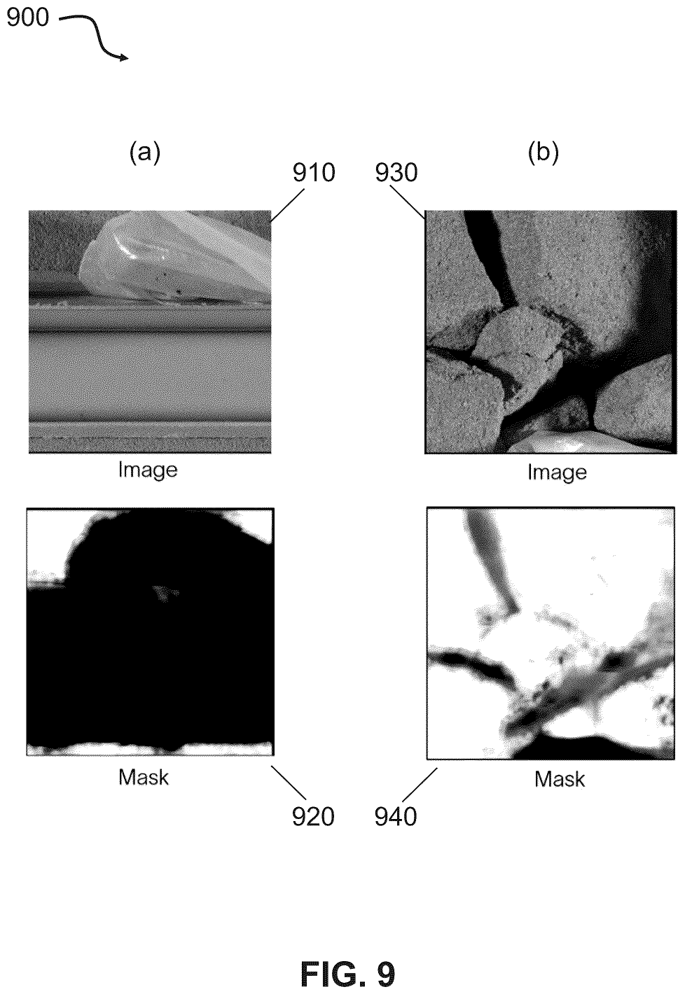

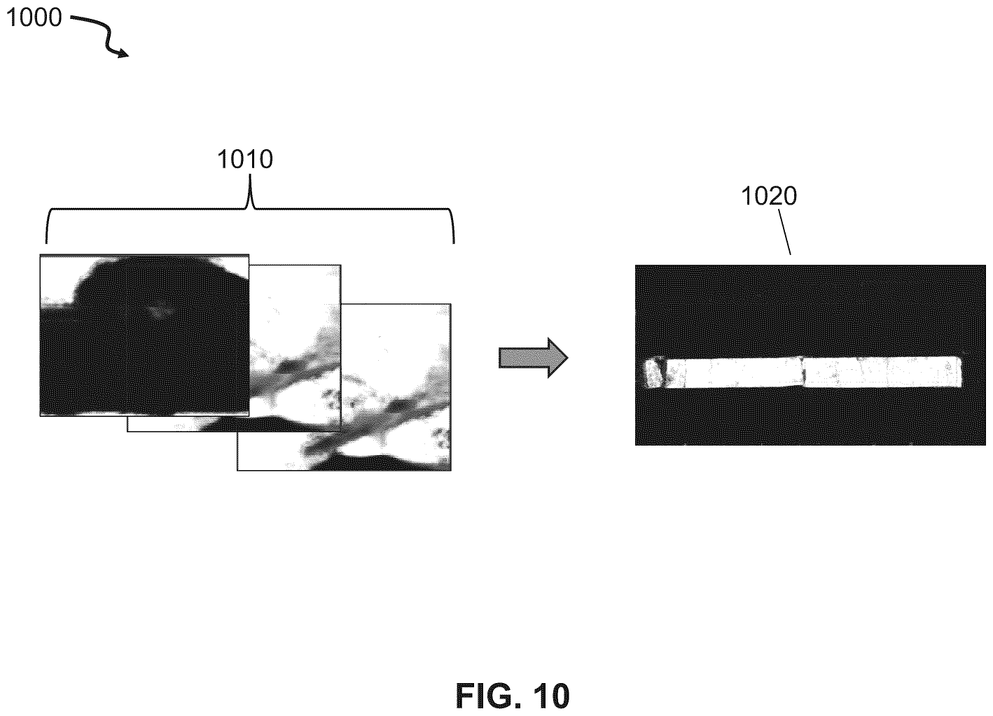

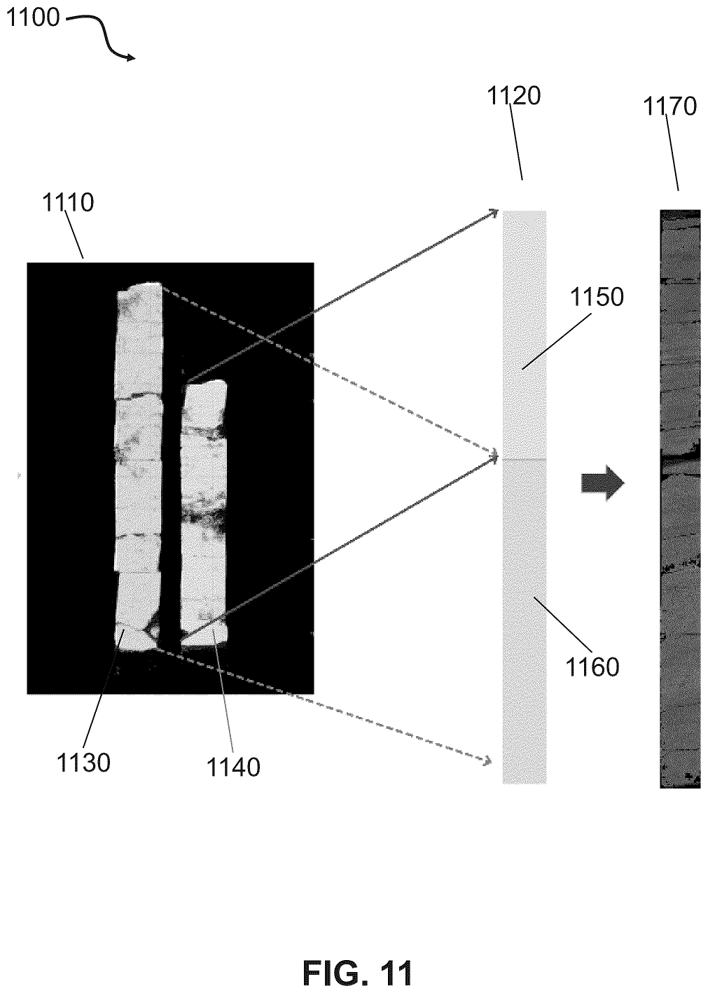

FIG. 9 is sets of image-mask pairs from experimental results. FIG. 10 is a flow of an example process for stitching mask chunks together. FIG. 11 is a flow of an example process for a vertical stacking algorithm.

In FIG. 9, an experimental set 900 of image-mask pairs from prediction exercise results using the U-Net are shown. In part (a), a first image 910 is paired with a first mask 920. In part (b), a second image 930 is paired with a second mask 940.

Stitching and post processing algorithm: Once the mask tiles are generated, they may be systematically reassembled to form the complete mask. This involves aligning each predicted mask tile back into its original position in the full image grid. The recomposed mask retains the spatial accuracy and highlights all regions of interest as identified in the prediction phase. This meticulous tiling and recomposition process allows for the efficient handling of large images, ensuring that the full masked image accurately reflects the segmented regions predicted by the neural network. Post processing may keep pixels that are thresholded for a single channel image, for example, where greyscale pixel values >0.95.

FIG. 10 shows an example process 1000 for stitching mask chunks together, e.g., using a stitching algorithm, to get the full masked image, e.g., in the native resolution of the original input image. In FIG. 10, a set of mask chunks 1010 are stitched together to create a full masked image 1020.

Vertical stacking algorithm: The stitching (or stacking) algorithm may be designed to combine and align multiple segmented regions from processed images into a coherent stack, which may be, for example, vertical or horizontal. Initially, the algorithm processes each image to identify the segment regions of interest (ROIs) from the final image masks. Each detected segment may then be rotated if required, e.g., to ensure consistent orientation for stacking. The segments may be ordered from top to bottom, e.g., prioritizing segments as per their arrangement on the tray, which may correspond to the depths of the rock core sample. This logic and/or arrangement may be unique for each unique core tray arrangement convention, which may differ from case to case, depending on how the physical cores were laid in trays and/or how they were imaged. These ordered segments may be stacked, e.g., vertically, to form a single composite image containing all major segmented parts from the original image. The stacked segments may be stored in a depth-aware array, e.g., a NumPy array, which may allow for easy browsing and manipulation by depth value, for example, with a top depth as a starting point (e.g., top of the stack). The final stacked array may be visualized or displayed, for example, to ensure correctness. The image may be saved, for example, in red, green, blue (RGB) format or another image format, e.g., for further analysis.

FIG. 11 shows an example process 1100 for a vertical stacking algorithm for extracting regions of interest (or mask portions) using a generated image mask 1110 and stacking them in order depth-wise. A depth-order stack 1120 may be generated by stacking mask portions 1130, 1140 of the generated image mask 1110 corresponding to respective rock core sample tray sections. In the FIG. 11 example, the depth-order stack 1120 has depth-order portions 1150, 1160 respectively corresponding to the mask portions 1130, 1140. The process 1100 may then generate a color stack image 1170 of the stacked geological rock core samples.

Pseudo core generator CNN: The model architecture may be designed for predicting RGB color values and stack them depth wise from sequential numerical features in this case, well logs using a Convolutional Neural Network (CNN). The model may start with 1D convolutional layers (Conv1D) that capture temporal patterns in the input data, applying rectified linear unit (ReLU) activation functions to introduce non-linearity. Max pooling (MaxPooling1D) layers follow to downsample the feature maps, helping to highlight significant features while reducing computational complexity. The resulting feature maps are then flattened into a 1D vector and passed through dense (Dense) layers to progressively distill the learned representations. The example final dense layer comprises 3 units, corresponding to the RGB color channels, with a sigmoid activation function that may ensure that outputs are constrained between 0 and 1, which may be suitable for representing normalized color values. Example embodiments are not limited to three units or to values constrained between 0 and 1.

The model may be trained be showing average color stack images of existing core runs for corresponding log data. The model may be based on a reverse model of average color value extraction and stacking them for each sampling, even along the depth of the original image. Similarly, the stacking of predicted color stacks may give a rock-like representation to regions not having actual physical core collection.

A Jaccard index (or intersection over union (IoU)) and/or a Dice-Sorensen coefficient (or “Dice Coefficient”) may be used to gauge the similarity between the ground truth (or actual physical geological rock) and the predicted segmentation generated by the machine-learning trained model. In experimental results using an example embodiment, Jaccard IoU & Dice Coefficient results were obtained to provide insights into the performance of the segmentation model. The IoU measures the overlap between the predicted segmentation and the ground truth, and may have a value from 0 to 1. A higher IoU indicates better performance. In the experiment, an IoU of 0.95 suggested a high degree of overlap. The Dice Coefficient is another measure of overlap, emphasizing the agreement between the predicted and actual segments, and may have a value ranging from 0 to 1, with higher values indicating better performance. In the experiment, a Dice score of 0.97 indicated excellent performance.

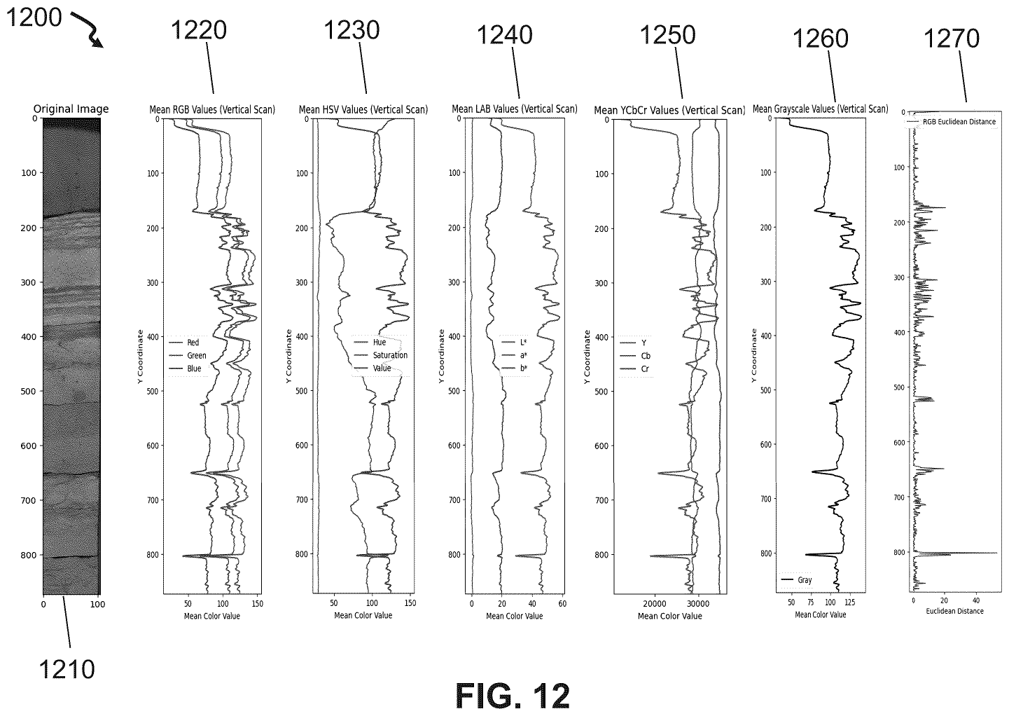

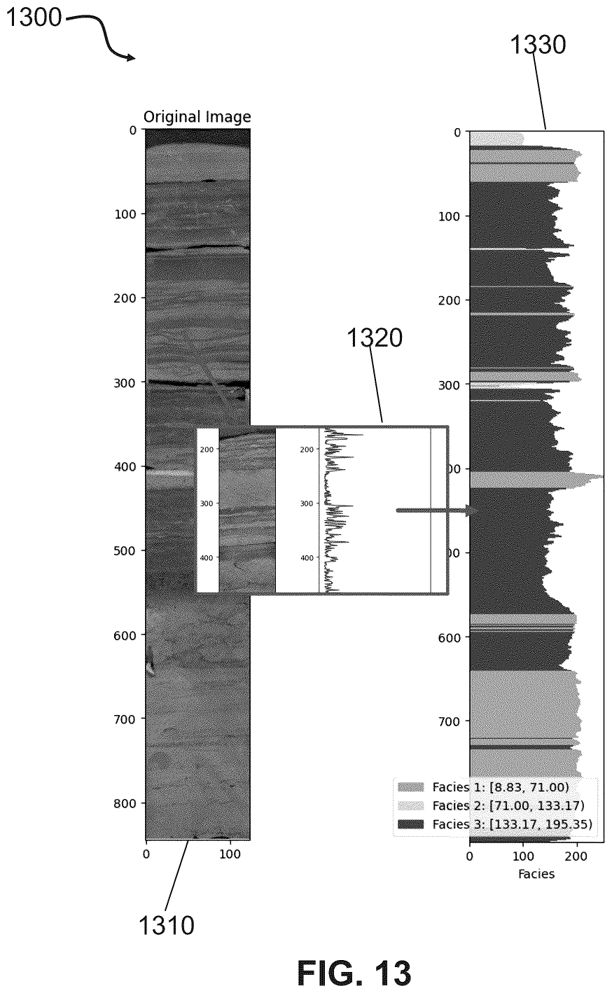

FIG. 12 is a workflow of an original image and a set of graphs corresponding to aspects of the original image. FIG. 13 is a workflow for generating a preliminary lithofacies log.

In FIG. 12, an example workflow 1200 may scan an original image 1210, which may correspond to a full vertical stack of the geological rock core sample. The example original image 1210 starts at a depth of 0 and increased along a depth in centimeters. The depth also corresponds to the y-axis on the graphs 1220, 1230, 1240, 1250, 1260, and 1270. A moving window, for example, of size [width of core segment*1 pixel length], may scan along the depth of the core stack to extract quantitative color and textural features from the high resolution images.

For example, graph 1220 shows mean red, green, and blue (RGB) values, graph 1230 shows mean hue, saturation, and value (or brightness (B)) (HSV) values, graph 1240 shows mean lightness (L*), red-green (a*), and blue-yellow (b*) (LAB) values, graph 1250 shows mean luminance (brightness, Y), chroma blue or blue minus luminance (B-Y, Cb), and chroma red or red minus luminance (R-Y, Cr) (YCbCr) values, graph 1260 shows mean greyscale values, and graph 1270 shows an RGB Euclidean distance. The RGB Euclidean distance graph 1270 may be a more quantifiable way of reading the various color representations, e.g., RGB, greyscale, LAB, YCbCr, etc., for example, by taking a three point Euclidean distance absolute value to plot and show intensity of variation on a 2D vector space. Thus, FIG. 12 shows plots of RGB, HSV, LAB, YCbCr, greyscale, and Euclidean distance values for the given core image after computer vision aided visual information collection and processing.

Computer vision sampling and U-Net feature extraction plots: Computer Vision (CV) may be used to load the vertically stacked slab images and represented as continuous RGB values for depth to create “color logs.” The color logs can then be converted into other color spaces, such as HSV, LAB, and YCbCr, e.g., using transformation functions. Sampling may be done using an overlapping sampling window, for example, of 1 pixel height. Each color space may serve different a purpose. For example, HSV may be useful for tasks involving color intensity and segmentation, while LAB may provide a perceptually uniform representation.

Additionally, a Euclidean distance method may calculate color similarity or difference, e.g., based on RGB values, by quantifying how close or distant colors are in a perceptual sense. This may be important, e.g., to delineate depth variation in rocks. The Euclidean Distance (E_{d}) is the straight-line distance in 3-D coordinate space between two points. It is given as in Equation 2 below.

E_{d}=sqrt((R1−R2)²+(G1−G2)²+(B1−B2)²) [Equation2]

In Equation 2, “sqrt” is a square root function (√), R1, G1, and B1 are RGB values in a first sampling window, and R2, G2, and B2 are RGB values in a second sampling window.

The features from CV extracted color data responses and feature information from the U-Net may be used to generate plots along the depth for the rock core slab images, using statistical distributions to classify visual “response” curves. This data may be represented as the litho-facies for the rock slab images. FIG. 13 shows an example of a preliminary lithofacies log, which was generated in an experiment using CV and U-Net responses for a given geological rock core in accordance with an example embodiment. As shown in FIG. 13, an example workflow 1300 may input an original image 1310, which may correspond to a full vertical stack of the rock core sample. A moving window 1320 may be applied to extract Euclidean Distance values along the length of the original image 1310. A facies classification chart 1330 may be a “visual response curve” that may be generated from the Euclidean Distance values that identifies the various geological facies along the rock core depicted in the original image 1310. In the FIG. 13 example, each color in the facies classification chart 1330 represents a different facies classification.

Variations in facies log channels: Additionally the “visual response curve” plotted above can also be a derivative of encoder of the U-Net, which itself may be capable of generating channels, alternative to RGB. As such, a workflow according to example embodiments may also be capable of plotting U-Net-generated feature channels, for example, to obtain further insights and finer facies delineations.

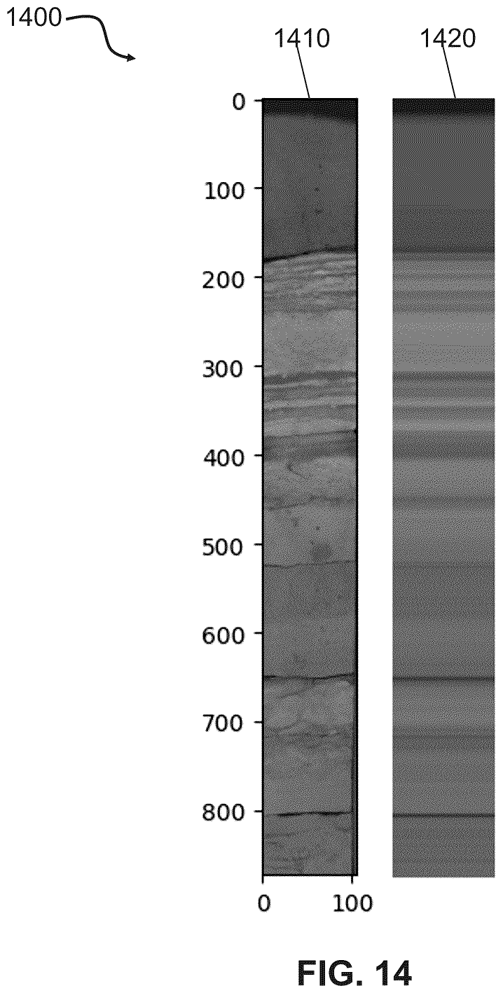

FIG. 14 is a comparison of an original rock core image to a synthetic rock core image.

In FIG. 14, a comparison 1400 shows a real core image (or original rock core) 1410 adjacent to a “pseudo core” (or synthetic rock core) 1420. The pseudo core 1420 was generated by experimental results using an example embodiment to illustrate an example result of a predicted color stack in regions without actual physical geological rock core recovery.

Example embodiments may extract images of geological rock core sample segments and transform them into one or more high-definition (or high-resolution) stacked core images. Example embodiments may predict the composition of missing physical core segments, and may provide a visual representation of the predicted missing physical core segments. Example embodiments may capture detailed lithological variation, for example, with advanced color analysis algorithms. Example embodiments may enrich geological core dataset workflows.

The lack of an end-to-end solution to standardize core data and to extract as much information possible given that it represents the true geological picture of the subsurface is a current unmet need. Facies information directly extracted from this dataset to aid in final analysis along with physical well logs would be greatly beneficial to oil and gas workflows. Example embodiments may provide a complete solution to streamline and enhance an otherwise underrated and underutilized dataset. As such, example embodiments may make advantageous use of a vast repository of such kind of data.

Example embodiments may provide data enrichment activities for third parties looking to enhance old data, for example, to increase or maximize digitization goals, as well as to aid older interpretation jobs. Example embodiments may be used as a standalone deployable solution, or may be part of a suite of applications, such as a plugin or a workflow within a suite of software products.

Conventional workflows, including plugins that aim to fulfill some of the tasks that example embodiments may streamline, are not coherent enough to get precise core imagery and are simply manually-aided bulk cropping methodologies. The value that example embodiments including machine-learning-enhanced workflows can bring may be superior to conventional offerings in geological core processing.

Conventional core interpretation is heavily reliant on human visual interpretations, which are largely subjective and error prone. That being said, core interpretation can change the understanding in the well, as well as at reservoir level, which may all be rooted in efficient analysis of lithofacies. Example embodiments may aid such efficient analysis, for example, using quantitative color science supported by neural networks.

Example embodiments may be used, for example, to capture fine details of the geological rock. For example, example embodiments may convert the enhanced stack into a quantitative graph and/or log. Example embodiments may convert the enhanced stack into a lithovariation report, which may include fine intricate changes in the rock. Example embodiments may provide a pseudo-rock stack, wherein holes or missing sections of the physical geological record may be filled in with synthetic depictions of rock in a fully-stacked visualization that can be displayed on a display device, for example, so that the full geological record may be viewed as a whole, or may be displayed, for example in user-selectable sections or scrolled through on the screen of the display device. Example embodiments may identify the locations of a target resource, e.g., oil, gas, or another material, in a displayed stack, even when parts of the geological rock core sample may have been missing or had gaps. When the enhanced stack is used to identify the location of a target resource, example embodiments may include performing a drilling operation to reach and/or recover the identified target resource.

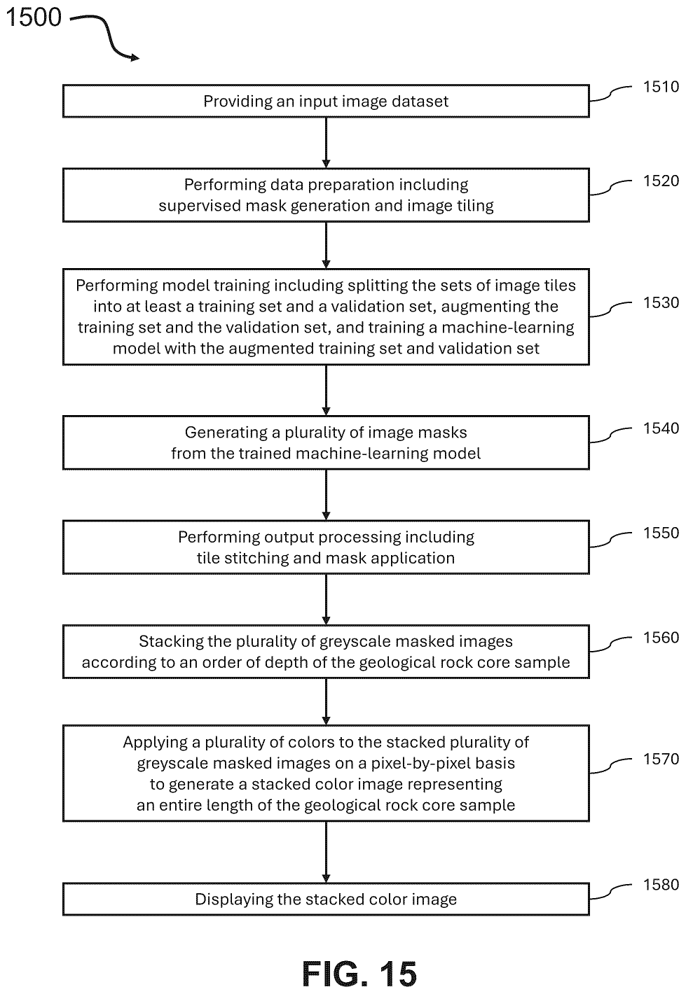

FIG. 15 is a flowchart of an example method 1500 for a geological rock core sample obtained from a geological formation. The method may include, at operation 1510, providing an input image dataset including a plurality of color images each corresponding to a portion of the geological rock core sample. The method may further include, at operation 1520, performing data preparation including: supervised mask generation including creating initial masks for a subset of the plurality of images, and image tiling including dividing each of the plurality of images into respective sets of image tiles. The method may further include, at operation 1530, performing model training including: splitting the sets of image tiles into at least a training set and a validation set, augmenting the training set and the validation set, the augmenting including orienting each image tile in the training set and the validation set in a same direction according to a depth of the geological rock core sample corresponding to each respective tile, and training a machine-learning model with the augmented training set and validation set. The method may further include, at operation 1540, generating a plurality of image masks from the trained machine-learning model, the plurality of image masks respectively corresponding to the plurality of images. The method may further include, at operation 1550, performing output processing including: tile stitching including combining the sets of image tiles to regenerate each of the plurality of images from their respective sets of image tiles, and mask application including applying the generated plurality of image masks to their corresponding to the plurality of color images on a pixel-by-pixel basis to generate a plurality of greyscale masked images. The method may further include, at operation 1560, stacking the plurality of greyscale masked images according to an order of depth of the geological rock core sample. The method may further include, at operation 1570, applying a plurality of colors to the stacked plurality of greyscale masked images on a pixel-by-pixel basis to generate a stacked color image representing an entire length of the geological rock core sample, the plurality of colors corresponding to colors of the geological rock core sample. The method may further include, at operation 1580, displaying the stacked color image.

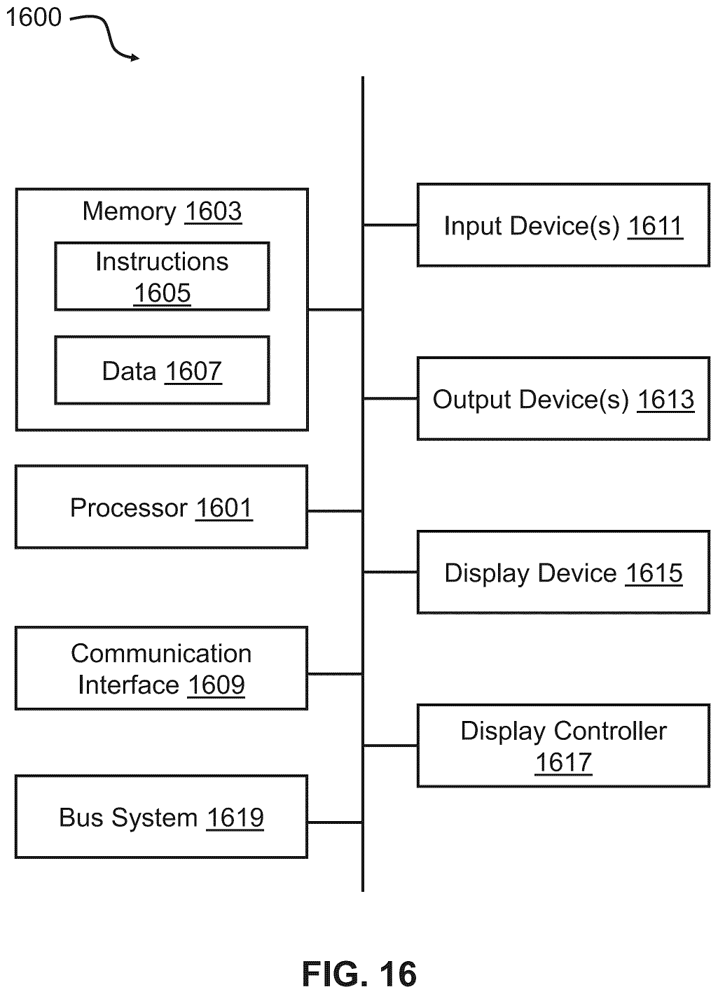

FIG. 16 illustrates certain components that may be included within a computer system according to an example embodiment of the present disclosure.

FIG. 16 illustrates certain components that may be included within a computer system 1600, which may be used to control features according to embodiments of the present disclosure, such as the features discussed with reference to FIGS. 1-15. One or more computer systems 1600 may be used to implement the various devices, components, and systems described herein.

The computer system 1600 includes a processor 1601. The processor 1601 may be a single processor or may include multiple processors and/or sub-processors. The processor 1601 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 1601 may be referred to as a central processing unit (CPU). Although just a single processor 1601 is shown in the computer system 1600 of FIG. 16, in an alternative configuration, a combination of processors (e.g., an ARM and DSP) could be used. In one or more embodiments, the computer system 1600 further includes one or more graphics processing units (GPUs), which can provide processing services related to both entity classification and graph generation.

The computer system 1600 also includes memory 1603 in electronic communication with the processor 1601. The memory 1603 may be any electronic component capable of storing electronic information. For example, the memory 1603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable medium, and so forth, including combinations thereof. The memory may include a single memory devices or multiple memory devices.

Instructions 1605 and data 1607 may be stored in the memory 1603. The instructions 1605 may be executable by the processor 1601 to implement some or all of the functionality disclosed herein. Executing the instructions 1605 may involve the use of the data 1607 that is stored in the memory 1603. Any of the various examples of modules and components described herein may be implemented, partially or wholly, as instructions 1605 stored in memory 1603 and executed by the processor 1601. Any of the various examples of data described herein may be among the data 1607 that is stored in memory 1603 and used during execution of the instructions 1605 by the processor 1601.

A computer system 1600 may also include one or more communication interfaces 1609 for communicating with other electronic devices. The communication interface(s) 1609 may be based on wired communication technology, wireless communication technology, or both. Some examples of communication interfaces 1609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1600 may also include one or more input devices 1611 and one or more output devices 1613. Some examples of input devices 1611 include a keyboard, mouse, microphone, remote control device, button, joystick, trackball, touchpad, and lightpen. Some examples of output devices 1613 include a speaker and a printer. One specific type of output device that is typically included in a computer system 1600 is a display device 1615. Display devices 1615 used with embodiments disclosed herein may utilize any suitable image projection technology, such as liquid crystal display (LCD), light-emitting diode (LED), gas plasma, electroluminescence, or the like. A display controller 1617 may also be provided, for converting data 1607 stored in the memory 1603 into text, graphics, and/or moving images (as appropriate) shown on the display device 1615.

The various components of the computer system 1600 may be coupled together by one or more buses, which may include a power bus, a control signal bus, a status signal bus, a data bus, etc. For the sake of clarity, the various buses are illustrated in FIG. 16 as a bus system 1619.

The following are sections in accordance with at least one embodiment of the present disclosure:

Clause 1: A method for a geological rock core sample obtained from a geological formation, the method including: providing an input image dataset including a plurality of color images each corresponding to a portion of the geological rock core sample, performing data preparation including: supervised mask generation including creating initial masks for a subset of the plurality of color images, and image tiling including dividing each of the plurality of color images into respective sets of image tiles, performing model training including: splitting the sets of image tiles into at least a training set and a validation set, augmenting the training set and the validation set, the augmenting including orienting each image tile in the training set and the validation set in a same direction according to a depth of the geological rock core sample corresponding to each respective tile, and training a machine-learning model with the augmented training set and validation set, generating a plurality of image masks from the trained machine-learning model, the plurality of image masks respectively corresponding to the plurality of color images, performing output processing including: tile stitching including combining the sets of image tiles to regenerate each of the plurality of color images from their respective sets of image tiles, and mask application including applying the generated plurality of image masks to their corresponding to the plurality of color images on a pixel-by-pixel basis to generate a plurality of greyscale masked images, stacking the plurality of greyscale masked images according to an order of depth of the geological rock core sample, applying a plurality of colors to the stacked plurality of greyscale masked images on a pixel-by-pixel basis to generate a stacked color image representing an entire length of the geological rock core sample, the plurality of colors corresponding to colors of the geological rock core sample, and displaying the stacked color image.

Clause 2: The method of clause 1, further including: determining whether there is at least one missing rock section in the geological rock core sample, when there is at least one missing rock section, generating a corresponding synthetic rock section model in place of each at least one missing rock section, each synthetic rock section model corresponding to a prediction of a geological type of the respective at least one missing rock section, the prediction being generated from well log data corresponding to the geological rock core sample, and displaying an enhanced color stacked image including: the stacked color image, and each synthetic rock section model in a respective location in the stacked color image corresponding to a location of the at least one missing rock section.

Clause 3: The method of clause 2, further including: generating facies classifications along an entire length of the enhanced stacked color image, and displaying the facies classifications on an electronic display device.

Clause 4: The method of clause 3, wherein the enhanced stacked color image includes a plurality of colors respectively corresponding to the facies classifications.

Clause 5: The method of clause 3, wherein the facies classifications are determined according to Euclidean distance values determined on a pixel-by-pixel basis from the enhanced stacked color image.

Clause 6: The method of clause 3, further including identifying a location of a target resource in the geological rock core sample based on the facies classifications.

Clause 7: The method of clause 6, further including performing a drilling operation to recover the target resource at a depth in the geological formation corresponding to the identified location of a target resource in the geological rock core sample.

Clause 8: The method of clause 1, wherein the machine-learning model includes a convolutional neural network (CNN) architecture.

Clause 9: The method of clause 8, wherein the CNN architecture includes a U-net segmentation model.

Clause 10: The method of clause 9, wherein the U-net segmentation model uses: a max pooling downsampling process, and a sigmoid activation function to generate the plurality of image masks.

Clause 11: A system, including: one or more processors, at least one memory including at least one non-transitory computer-readable medium storing instructions that, when executed by at least one of the one or more processors, cause the system to perform operations, the operations including: providing an input image dataset including a plurality of color images each corresponding to a portion of a geological rock core sample obtained from a geological formation, performing data preparation including: supervised mask generation including creating initial masks for a subset of the plurality of color images, and image tiling including dividing each of the plurality of color images into respective sets of image tiles, performing model training including: splitting the sets of image tiles into at least a training set and a validation set, augmenting the training set and the validation set, the augmenting including orienting each image tile in the training set and the validation set in a same direction according to a depth of the geological rock core sample corresponding to each respective tile, and training a machine-learning model with the augmented training set and validation set, generating a plurality of image masks from the trained machine-learning model, the plurality of image masks respectively corresponding to the plurality of color images, performing output processing including: tile stitching including combining the sets of image tiles to regenerate each of the plurality of color images from their respective sets of image tiles, and mask application including applying the generated plurality of image masks to their corresponding to the plurality of color images on a pixel-by-pixel basis to generate a plurality of greyscale masked images, stacking the plurality of greyscale masked images according to an order of depth of the geological rock core sample, applying a plurality of colors to the stacked plurality of greyscale masked images on a pixel-by-pixel basis to generate a stacked color image representing an entire length of the geological rock core sample, the plurality of colors corresponding to colors of the geological rock core sample, and displaying the stacked color image.

Clause 12: The system of clause 11, wherein the operations further include: determining whether there is at least one missing rock section in the geological rock core sample, when there is at least one missing rock section, generating a corresponding synthetic rock section model in place of each at least one missing rock section, each synthetic rock section model corresponding to a prediction of a geological type of the respective at least one missing rock section, the prediction being generated from well log data corresponding to the geological rock core sample, and displaying an enhanced color stacked image including: the stacked color image, and each synthetic rock section model in a respective location in the stacked color image corresponding to a location of the at least one missing rock section.

Clause 13: The system of clause 12, wherein the operations further include: generating facies classifications along an entire length of the enhanced stacked color image, and displaying the facies classifications on an electronic display device.

Clause 14: The system of clause 13, wherein the enhanced stacked color image includes a plurality of colors respectively corresponding to the facies classifications.

Clause 15: The system of clause 13, wherein the facies classifications are determined according to Euclidean distance values determined on a pixel-by-pixel basis from the enhanced stacked color image.

Clause 16: The system of clause 13, wherein the operations further include identifying a location of a target resource in the geological rock core sample based on the facies classifications.

Clause 17: The system of clause 16, wherein the operations further include performing a drilling operation to recover the target resource at a depth in the geological formation corresponding to the identified location of a target resource in the geological rock core sample.

Clause 18: The system of clause 11, wherein the machine-learning model includes a convolutional neural network (CNN) architecture.

Clause 19: The system of clause 18, wherein the CNN architecture includes a U-net segmentation model.

Clause 20: The system of clause 19, wherein the U-net segmentation model uses: a max pooling downsampling process, and a sigmoid activation function to generate the plurality of image masks.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another.

Moreover, it should be appreciated that such a development effort might be complex and time consuming, but would nevertheless be a routine undertaking of design, fabrication, and manufacture for those of ordinary skill having the benefit of this disclosure. All trademarks are the property of their respective owners.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for a geological rock core sample obtained from a geological formation, the method comprising:
providing an input image dataset comprising a plurality of color images each corresponding to a portion of the geological rock core sample;
performing data preparation comprising:
supervised mask generation comprising creating initial masks for a subset of the plurality of color images; and
image tiling comprising dividing each of the plurality of color images into respective sets of image tiles;
performing model training comprising:
splitting the sets of image tiles into at least a training set and a validation set;
augmenting the training set and the validation set, the augmenting comprising orienting each image tile in the training set and the validation set in a same direction according to a depth of the geological rock core sample corresponding to each respective tile; and
training a machine-learning model with the augmented training set and validation set;
generating a plurality of image masks from the trained machine-learning model, the plurality of image masks respectively corresponding to the plurality of color images;
performing output processing comprising:
tile stitching comprising combining the sets of image tiles to regenerate each of the plurality of color images from their respective sets of image tiles; and
mask application comprising applying the generated plurality of image masks to their corresponding to the plurality of color images on a pixel-by-pixel basis to generate a plurality of greyscale masked images;
stacking the plurality of greyscale masked images according to an order of depth of the geological rock core sample;
applying a plurality of colors to the stacked plurality of greyscale masked images on a pixel-by-pixel basis to generate a stacked color image representing an entire length of the geological rock core sample, the plurality of colors corresponding to colors of the geological rock core sample; and
displaying the stacked color image.

2. The method of claim 1, further comprising:
determining whether there is at least one missing rock section in the geological rock core sample;
when there is at least one missing rock section, generating a corresponding synthetic rock section model in place of each at least one missing rock section, each synthetic rock section model corresponding to a prediction of a geological type of the respective at least one missing rock section, the prediction being generated from well log data corresponding to the geological rock core sample; and
displaying an enhanced color stacked image comprising:
the stacked color image; and
each synthetic rock section model in a respective location in the stacked color image corresponding to a location of the at least one missing rock section.

3. The method of claim 2, further comprising:
generating facies classifications along an entire length of the enhanced stacked color image; and
displaying the facies classifications on an electronic display device.

4. The method of claim 3, wherein the enhanced stacked color image comprises a plurality of colors respectively corresponding to the facies classifications.

5. The method of claim 3, wherein the facies classifications are determined according to Euclidean distance values determined on a pixel-by-pixel basis from the enhanced stacked color image.

6. The method of claim 3, further comprising identifying a location of a target resource in the geological rock core sample based on the facies classifications.

7. The method of claim 6, further comprising performing a drilling operation to recover the target resource at a depth in the geological formation corresponding to the identified location of a target resource in the geological rock core sample.

8. The method of claim 1, wherein the machine-learning model comprises a convolutional neural network (CNN) architecture.

9. The method of claim 8, wherein the CNN architecture comprises a U-net segmentation model.

10. The method of claim 9, wherein the U-net segmentation model uses:
a max pooling downsampling process; and
a sigmoid activation function to generate the plurality of image masks.

11. A system, comprising:
one or more processors;
at least one memory comprising at least one non-transitory computer-readable medium storing instructions that, when executed by at least one of the one or more processors, cause the system to perform operations, the operations comprising:
providing an input image dataset comprising a plurality of color images each corresponding to a portion of a geological rock core sample obtained from a geological formation;
performing data preparation comprising:
supervised mask generation comprising creating initial masks for a subset of the plurality of color images; and
image tiling comprising dividing each of the plurality of color images into respective sets of image tiles;
performing model training comprising:
splitting the sets of image tiles into at least a training set and a validation set;
augmenting the training set and the validation set, the augmenting comprising orienting each image tile in the training set and the validation set in a same direction according to a depth of the geological rock core sample corresponding to each respective tile; and
training a machine-learning model with the augmented training set and validation set;
generating a plurality of image masks from the trained machine-learning model, the plurality of image masks respectively corresponding to the plurality of color images;
performing output processing comprising:
tile stitching comprising combining the sets of image tiles to regenerate each of the plurality of color images from their respective sets of image tiles; and
mask application comprising applying the generated plurality of image masks to their corresponding to the plurality of color images on a pixel-by-pixel basis to generate a plurality of greyscale masked images;
stacking the plurality of greyscale masked images according to an order of depth of the geological rock core sample;
applying a plurality of colors to the stacked plurality of greyscale masked images on a pixel-by-pixel basis to generate a stacked color image representing an entire length of the geological rock core sample, the plurality of colors corresponding to colors of the geological rock core sample; and
displaying the stacked color image.

12. The system of claim 11, wherein the operations further include:
determining whether there is at least one missing rock section in the geological rock core sample;
when there is at least one missing rock section, generating a corresponding synthetic rock section model in place of each at least one missing rock section, each synthetic rock section model corresponding to a prediction of a geological type of the respective at least one missing rock section, the prediction being generated from well log data corresponding to the geological rock core sample; and
displaying an enhanced color stacked image comprising:
the stacked color image; and
each synthetic rock section model in a respective location in the stacked color image corresponding to a location of the at least one missing rock section.

13. The system of claim 12, wherein the operations further include:
generating facies classifications along an entire length of the enhanced stacked color image; and
displaying the facies classifications on an electronic display device.

14. The system of claim 13, wherein the enhanced stacked color image comprises a plurality of colors respectively corresponding to the facies classifications.

15. The system of claim 13, wherein the facies classifications are determined according to Euclidean distance values determined on a pixel-by-pixel basis from the enhanced stacked color image.

16. The system of claim 13, wherein the operations further include identifying a location of a target resource in the geological rock core sample based on the facies classifications.

17. The system of claim 16, wherein the operations further include performing a drilling operation to recover the target resource at a depth in the geological formation corresponding to the identified location of a target resource in the geological rock core sample.

18. The system of claim 11, wherein the machine-learning model comprises a convolutional neural network (CNN) architecture.

19. The system of claim 18, wherein the CNN architecture comprises a U-net segmentation model.

20. The system of claim 19, wherein the U-net segmentation model uses:
a max pooling downsampling process; and
a sigmoid activation function to generate the plurality of image masks.
